(19) United States
(12) Patent Application Publication
(10) Pub. No.: US 2015/0367227 A1
(43) Pub. Date: Dec. 24, 2015

(54) INTERACTION OF VIDEO PROJECTION AND EFFECTS LIGHTING WITH BOWLING SCORING SYSTEM AND METHODS OF USE

(71) Applicant: QUBICAAMF EUROPE S.P.A., Bologna (IT)

(72) Inventors: Roberto Vaioli, Ozzano dell'emilia (IT); Samuel R. Namala, Mechanicsville, VA (US); Massimo Baraldi, Bologna (IT); Frank G. Kovach, Glen Allen, VA (US); Tommaso Parisi, Bologna (IT); Kelly J. Wilbar, Coconut Creek, FL (US)

(21) Appl. No.: 14/746,150

(22) Filed: Jun. 22, 2015

Related U.S. Application Data
(60) Provisional application No. 62/015,049, filed on Jun. 20, 2014.

(51) Int. Cl. A63D 5/04; G06T 11/40; H05B 37/02

(52) U.S. Cl. CPC A63D 5/04; H05B 37/029; G06T 11/40; A63D 2005/048

(57) ABSTRACT

Interactive bowling systems using scoring systems and/or other computer infrastructures which interact with visual and/or audio effects within the bowling center. A special effects system includes a special effects system which displays images or effects covering a masking wall over an entire width of bowling lanes or portions thereof in a bowling center to provide a global effect within the bowling center. The special effects system further includes a video mask system which has a bidirectional communication with a management system and a scoring system, the video mask system directing the special effects systems to display a special effects on the masking wall over the entire width of the bowling lanes or portions thereof.

### CROSS REFERENCE TO RELATED APPLICATIONS

The present invention incorporates by reference herein in its entirely U.S. Publication No. 2013/0324272, commonly owned by Applicants' of the present invention.

### FIELD OF THE INVENTION

The invention relates to bowling systems and, more particularly, to interactive bowling systems using scoring systems and/or other computer infrastructures which interact with visual and/or audio effects within the bowling center.

### SUMMARY

In aspects of the invention, and by implementing the systems and devices described herein, a global video game is based on scoring events generated on lanes, elaborated by the scoring or management system to produce a global video effect visible as a single video on all the centers lanes or their subsets. A video mask projecting surface is a unique seamless projecting surface, allowing a displaying of images or effects covering the entire width of the lanes. The content projected on this surface can be a global unique image/video/light special effect or more separate special effects, displayed individually in correspondence of single lanes or group of lanes. An audio, visual, lighting sequences triggered by “Bowling Modes” are predefined sets of parameters configured in the management system in order to automate management system controlled operations, wherein bowling modes can prescribe that a certain type of lighting is switched on at a predetermined hour of a predetermined day of the week. Additional parameters that can be used to set Bowling Modes are the type of customer, the type of bowling grid and animation theme chosen for the overhead monitors. In optional embodiments, a combination of two or more of these parameters can be used by the system to trigger one or more special effects to begin.

In embodiments, integration of scoring and management system with the special effect devices allows automatically control of the special effects according to the Bowling Modes method, but also allows a direct manual control of each special effect device connected to the system, semi automated control as in when a set of special effect instructions are predefined to trigger a sequence or a combination of effects but they need an initial manual trigger, wherein the manual or automatic control extends to each individual special effect and to each individual context of use, such as in the possibility to control special effects at each bowling center lane level, with a different effect or combination of effects for each lane, up to having the same special effect on a predefined set of lanes, up to having a single combination of all special effects working at the bowling center level, with center-wide effects.

Effects instructions sets at one bowling center, both those predefined and those custom-defined by the center operators, are shared with other bowling centers, and stored in a format allowing copying and transferring to a compatible system. Effects comprise execution initiated manually by a bowling center operator or a bowler, automatically in response to a bowling game event recorded by the scoring system or to a scoring system set up, such as the scoring grid and animations theme active on a lane, and automatically in response to one or more predefined parameters not related to the scoring system activity such as the time of the day, the type of customer on the lanes, the number of lanes open or combinations thereof and other features disclosed herein. Also, the systems complement the scoring video content displayed on the scoring monitors with additional and related content on the masking video unit wall as disclosed herein. Graphic templates are made available to users to help create audio, video, lighting effects, for example for embedding existing images or videos in predetermined graphic settings, such as uploading a picture of the winning bowler to the system, which then combines it with a predefined graphic such as a frame and then displays it on the video masking wall. Display global exciters are provided, such as a center-wide visual effect focusing on one lane in case a specific event happens, such as a strike, a spare or a special game win and/or examples as disclosed herein.

In embodiments, the systems display on entire width of the video mask wall, or on a video mask wall portion, graphical representation of a global game based on bowling game events happening on the lanes, directly based on each bowler current score, on a random/chance-based game mechanism involving all or a subset of the bowlers currently playing in the center, or also including bowlers or individuals not currently bowling but physically present at the center (such as bowlers whose data are already stored in the management system database, already checked-in to play at a lane, but not playing yet).

Mixing sound background effects with center wide music including ambient lighting are provided. Mood settings are provided with the ability of the customer, the center's operators or the management system in an automated way to set the “mood” for one or more lanes, up to all the lanes and to the entire center, by having the system control the special effect devices in order to generate a specific combination of audio, video and lighting effects meant to elicit an emotional response by the individuals present in the bowling center. Mood setting can also be seen as an extension of the ambient lighting. The systems project a static image on the masking units to mimic a static printed masking unit, allowing centers that need to have non-distracting animated graphing on the masking units in some contexts (league playing) to replicate the look and feel of a standard static printed masking unit. The image projected can be non-static, but designed in a way as not to distract the bowlers, such as a slow moving image, that can be different for each lane or for groups of lanes or a global image for the entire masking unit wall, or an image, static or moving, displayed on all the bowling center surfaces not limited to the lanes, including side walls and other walls of the bowling center and of the ancillary and connected rooms and environments, such as the bowling center restaurant.

Bowling center operators can feed one or more video sources, as TV, DVD, streaming video or audio signals, to the integrated audio, video, lighting system for redistribution inside the center, wherein in any combination one or more signals could be fed to the “mood generator” sub-system to be processed and displayed or projected on selected bowling center surfaces together with the matching lighting conditions, one of more signals could be alternatively or simultaneously fed to the integrated audio, video, lighting system for display or projection on bowling centers surfaces at the same time of the “mood” content is displayed.

In further embodiments, a special effects system comprises: one or more special effects components which display images or effects on a projecting surface in a bowling center to provide a global effect within the bowling center; and a graphic content processing system which has a bidirectional communication with a management system and a scoring system, the graphic content processing system directing the special effects components to display special effects on the projecting surface over the entire width of the bowling lanes or portions thereof. The projecting surface comprises masking units for at least each bowling lane and the masking units are a unified surface extending over the entire width of the bowling lanes or portions thereof, and the special effects system treats as a single element all of the masking units or a portions thereof. The one or more special effects components includes one or more video projectors, with the special effects system manages the synchronization of the audio/video outputs among the one or more video projectors to provide a unified video content. The graphic content processing system and user I/O devices including scoring consoles are in communication with one another, and the graphic content processing system receives inputs which trigger the special effects from the I/O devices, and the graphic content processing system sends inputs to the scoring system to trigger scoring-related behaviors on one or more masking units associated with a respective bowling lane. In embodiments, content to be displayed by the graphic content processing system is activated by an event or a status relayed by the scoring system. The content is related to a scoring event at a single bowling lane and the content is displayed on a masking unit of the single bowling lane in which the scoring event took place. The content is displayed on the entire projecting surface and is dedicated to a specific bowling lane related to the scoring event at the specific bowling lane. The content includes a sequence of projections displayed on the entire projecting surface and stopping at the specific bowling lane. In embodiments, wherein one of: a detected event by the graphic content processing system triggers activation of a different status of the scoring system; when an event of the scoring system happens in conjunction with an event of the graphic content processing system, the event of the scoring system will trigger a specific behavior of the graphic content processing system; and the event of the scoring system will trigger a specific behavior of the management system. The graphic content processing system will direct the special effects components to display the special effects on the projecting surface over the entire width of bowling lanes or portions thereof, independently from the scoring system. The management system records an event of a bowler in order to award a prize.

In further embodiments, a video mask projection system, comprises: a unified projecting surface; and at least one special effect device which displays images or effects covering an entire width of the bowling lanes or portions thereof, wherein the displayed images projected on the unified projecting surface comprise at least one of a global image, video and light displayed individually in correspondence of single lanes or group of lanes, which is controlled independently of a scoring system and which can be integrated with a scoring system. The content is a global video game based on scoring events generated on the bowling lanes, which comprises a global video effect visible as a single video on all masking units or subsets thereof, independent of a score recorded by the scoring system. The scoring system and a management system are integrated with the special effect devices and which are configured to automatically control special effects according to bowling modes, including a direct manual control, an automatic control or a semiautomatic control of each special effect device connected to the scoring system and the management system. The semi automated control comprises a set of special effect instructions predefined to trigger a sequence or a combination of effects but with an initial manual trigger, on a predefined set of bowling lanes. The special effect devices are triggered by predefined parameters not related to the scoring system.

In further embodiments, a system comprises: a scoring system configured to manage at least one bowling lane including processing events related to the at least one bowling lane; and one or more special effects components managed by the scoring system and configured to provide special effects in response to an occurrence of a status of the scoring system on the at least one bowling lane, wherein, upon the occurrence of the status, the scoring system: determines that the one or more bowling lanes status is associated with one or more special effect components; and provides instructions to the one or more special effect components associated to the status to provide the special effects. The status of at least one bowling lane is one of: being not available for playing, being available for playing but not currently used, being available for playing, and being currently used for a bowling game. The status of the at least one bowling lane is defined by one of: a theme characterizing audio/video content displayed on scoring overhead monitors; a characteristic of the audio/video content displayed on the scoring overhead monitors; and one or more characteristics of a setup at the at least one bowling lane, comprising at least one of: type of bowling game currently played, type of non-bowling game currently played, type of customers, and status of game. The status of the at least one bowling lane is determined by a management system through a bowling mode. A bowling lane status is defined as a set of predefined parameters that according to their nature can be defined by bowling center operators, by bowlers directly using bowling consoles, or automatically. The predefined parameters include at least one of graphic theme of a scoring grid, scoring animations, name and gender of bowlers, type of activity, highest score of the lane, average score of the lane, and lane ranking in a tournament.

### BRIEF DESCRIPTION OF THE DRAWINGS

The present invention is described in the detailed description which follows, in reference to the noted plurality of drawings by way of non-limiting examples of exemplary embodiments of the present invention.

FIG. 1 shows a representative bowling center in accordance with aspects of the present invention;

FIG. 2 shows a representative bowling scoring and management system which implements aspects of the present invention; and

FIG. 3 shows a representative computer infrastructure, which can be representative of a bowling scoring and/or management system.

### DETAILED DESCRIPTION

The invention relates to bowling systems and, more particularly, to interactive bowling systems comprising scoring systems and/or other computer infrastructures of the bowling center which interacts with and/or manages Special Effects within the bowling center.

Special Effects can be, for example, any entertainment related effects that enhance or complement the gaming, e.g., bowling, experience, including video projection, multi-colored lighting, laser effects, audio effects, and/or fog/haze effects, which may or may not contain cameras or sensors for interactivity with the bowler and/or the bowling ball.

It should be understood by those of ordinary skill in the art, though, that these Special Effects noted above are merely illustrative examples, and that other effects, whether they are visual, audio or tactile, are contemplated by the present invention.

More specifically, the present invention contemplates interacting Special Effects with a bowling scoring and management system. In this way, the bowling scoring and/or management system of a bowling center can control and/or manage the Special Effects content to be delivered within the bowling center, in order to behave with some meaningful interaction based on information available to a bowling scoring system. This information can be, illustratively, detection of a person or bowling ball at a certain location within the bowling center, e.g., crossing over a foul line, scoring events such as a strike, etc.

Thus, the present invention contemplates an interactive system comprising Special Effects used in bowling centers, managed by a bowling scoring and management system. This allows the Special Effects content to respond to the scoring games and events occurring on the bowling lane (and that are known and managed usually by the scoring system).

The result is that the bowling scoring and management system can drive and also affect the Special Effects content (either with or without a camera/detection device for interactivity with the bowler and/or bowling ball).

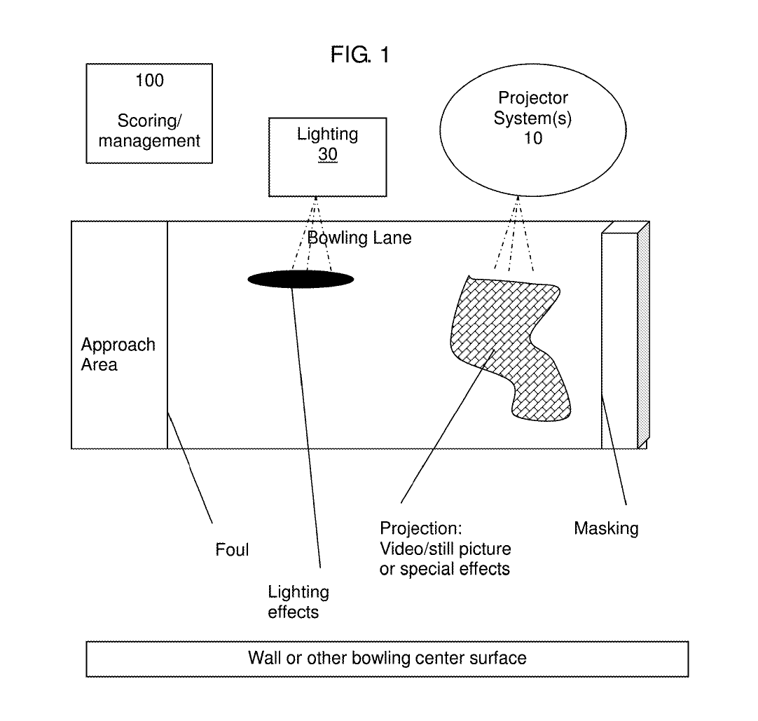

Referring to FIG. 1, in embodiments, the present invention utilizes a video projection system 10 to display Special Effects onto Bowling Center Surfaces.

Bowling center surfaces can be, for example, floors, walls, ceilings, masking units, bowling pins, bowling lanes, and bowler approaches in the bowling center. It should be understood by those of ordinary skill in the art, though, that these bowling center surfaces are merely illustrative examples, and that any surface within the bowling center are contemplated by the present invention such as, for example, any surface of any system that is used in the bowling center.

More specifically, special effects may include a video projector system 10 which includes, for example, one or more video projector units able to project video content onto a masking unit at the end of the bowling lanes that is suitable to receive this content, as well as projecting content onto the bowling lane or approach area, or any other surface on the bowling center to add video content and/or effect to the bowling center environment.

In embodiments, the special effects may include a video projection system 10 that incorporates a camera or other detection device to identify people and objects that cross onto the video projection surface area and which enables the systems of the present invention, e.g., bowling scoring and management system 100, to react and change the image being displayed by the video projection system 10 according to the motion of the person or object/objects in the video projection display area.

In further implementations, the present invention can implement the use of multi-color lighting fixtures 30, e.g., LED lighting, above the bowling lanes in which the multi-color lighting fixtures, e.g., LED lighting, project lighting effects onto the lane surface (or other surfaces), changing the color appearance of the lane surface and creating a visual effect on the bowling lanes, any of which can be controlled by a scoring system and/or centralized management system.

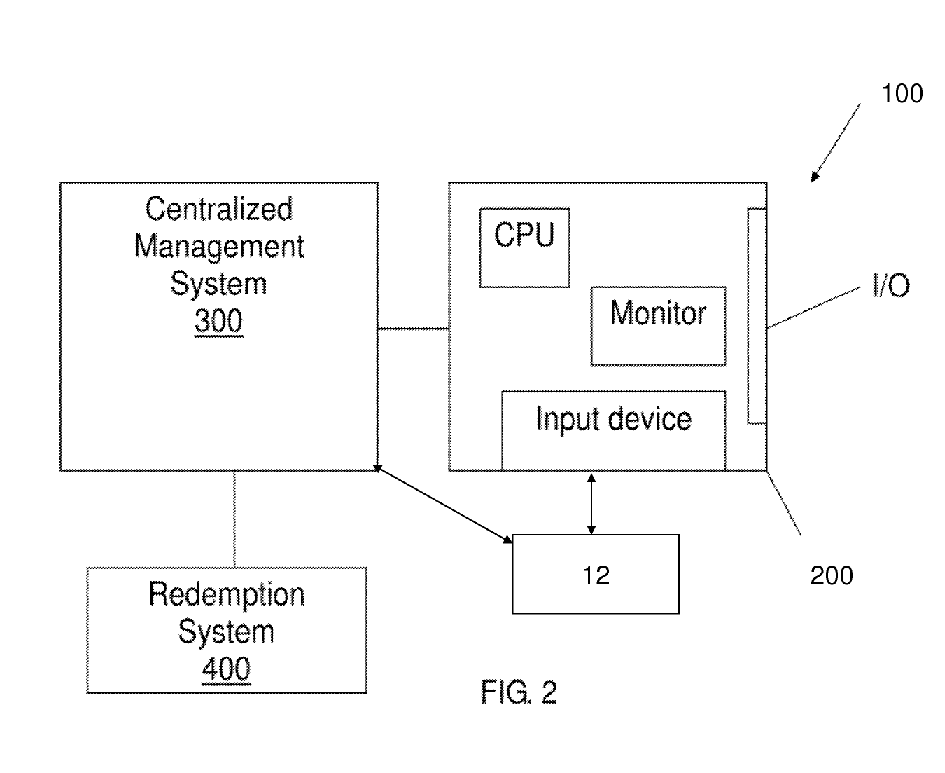

As shown in FIG. 2, in embodiments, the bowling center will include a bowling scoring and management system 100. The bowling scoring and management system 100 comprises, for example, the following features:

1. “Lane-Score-Computer” 200: The Lane-Score-Computer 200 is a computerized system that manages games on a lane, or a multiple of lanes. The example described herein assumes one pair of lanes; although other configurations are also contemplated by the present invention. In embodiments, the scoring system includes a main CPU that is connected to:

(i) A local monitor (typically overhead display monitor above the lane)

(ii) I/O devices to interface with the pinspotting machines;

(iii) I/O devices to collect information regarding when a ball is thrown, how many pins have fallen, if a foul has been detected, and other information available on the lane about the ball that was bowled; and

(iv) I/O console device (keypad, LCD, or similar) to allow the scoring system to interact locally on the lane with the bowlers.

2. “Centralized Management System” 300: In embodiments, the centralized management system 300 is a computerized system comprising one or more computers located at the counters and back office of the bowling center. This system allows the manager/employees of the bowling center to manage the customers from check-in to check-out. One of the main functions performed by the management system is to send the necessary information to set up the Lane-Score-Computer, which then takes care of the game being bowled on the lane. At the end of the game the management system collects the necessary information from the Lane-Score-Computer in order to manage the game scores, rankings, payments, etc. The centralized management system 300 can control/manage any of the features of the present invention.

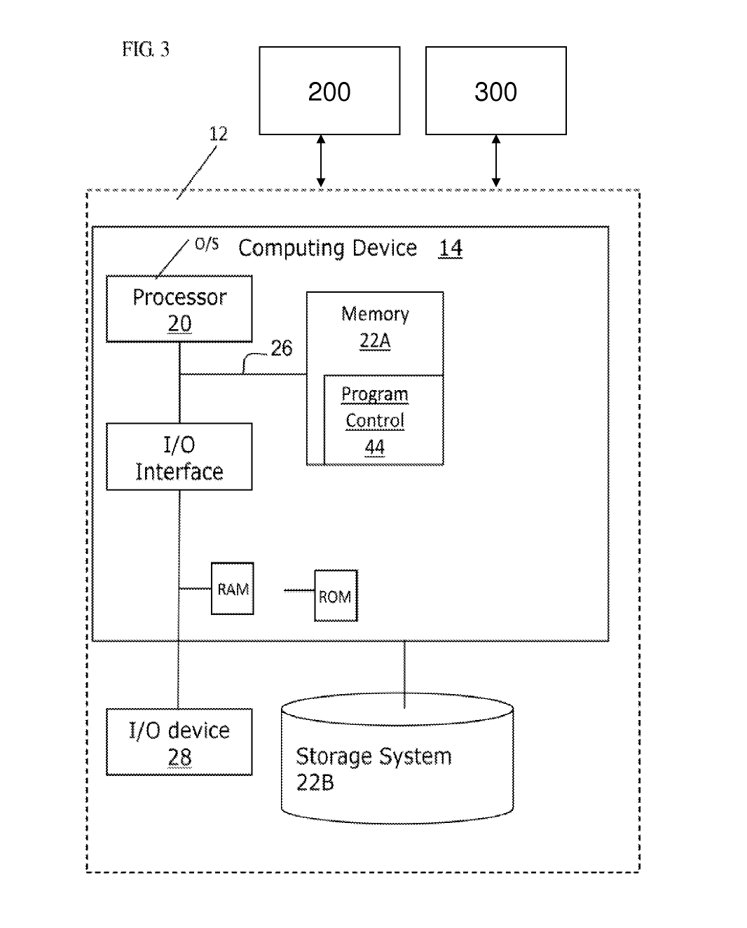

FIG. 3 shows a representative computer infrastructure, which can be representative of a bowling scoring and/or management system. Illustratively, the computer infrastructure can be representative of either the Lane-Score-Computer 200 or centralized management system 300 or the graphic content processing system which has a bidirectional communication with a management system 300 and a scoring system 200 (as shown in FIG. 3). To this extent, the computer infrastructure includes a server or other computing system 12 that can perform the processes described herein, including those of the graphic content processing system (which is represented as reference number 12) and which has a bidirectional communication with a management system 300 and scoring system 200, as shown representatively in FIG. 3. In particular, the server 12 includes a computing device 14. The server 12 and/or computing device 14 can communicate over any communication link such as an intranet, LAN, WAN, Internet, etc. The computing device 14 can be resident on a network infrastructure or computing device of a third party service provider.

The computing device 14 also includes a processor 20, memory 22A, an I/O interface 24, and a bus 26. In addition, the computing device includes random access memory (RAM), a read-only memory (ROM), and an operating system (O/S). The computing device 14 is in communication with the external I/O device/resource 28 and the storage system 22B. The I/O device 28 can comprise any device that enables an individual to interact with the computing device 14 (e.g., user interface) or any device that enables the computing device 14 to communicate with one or more other computing devices using any type of communications link.

The external I/O device/resource 28 may be for example, a handheld device, tablet, smartphone, PDA, handset, keyboard, a system converting sounds into electrical signals sent to the scoring or management system and generating a relevant event used to trigger a special effect, etc.

In general, the processor 20 executes computer program code (e.g., program control 44), which can be stored in the memory 22A and/or storage system 22B. The program control 44 provides the processes described herein. The program control 44 can be implemented as one or more program code stored in memory 22A as separate or combined modules. Additionally, the program control 44 may be implemented as separate dedicated processors or a single or several processors to provide the function of these tools. While executing the computer program code, the processor 20 can read and/or write data to/from memory 22A, storage system 22B, and/or I/O interface 24. The bus 26 provides a communications link between each of the components in the computing device 14.

As will be appreciated by one skilled in the art, the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects. Furthermore, aspects of the present invention may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM),an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Referring now to FIGS. 1-3, in operation, a video signal can be delivered to the video projector system such as a movie, TV channel, but also contemplated by the present invention is a computer-processed video content received from the Centralized Management System 300.

The video source can be managed by a computerized system (e.g., the centralized management system 300 or a graphic content processing system which has a bidirectional communication with a management system 300 and a scoring system 200), so that each video projector of multiple projectors could display video and/or other effects in accordance with aspects of the present invention. It should also be understood by those of skill in the art that the computer infrastructure of FIG. 2 can be implemented with the graphic content processing system 12 which has a bidirectional communication with a management system 300 and scoring system 200. In embodiments, the graphic content processing system has a bidirectional communication with a management system and a scoring system, directing the special effects components to display special effects on the projecting surface over the entire width of the bowling lanes or portions thereof. For example, each video projector can display a different portion of the original video signal so that the combination of the video projectors generates a bigger picture. This is referred to as a matrix video wall (i.e., a 3×3 display matrix can display a single video into an area 9 times larger than the single projector).

Inside a bowling center this technique can be used on a video mask to display a single and very large picture, a movie across all lanes in the bowling center, or an advertising banner moving/scrolling across all lanes in a bowling center (for example from lanes 1 to lane 30), or a global video game based on the scoring events generated on the lanes, elaborated by the scoring or the management system to produce a global video effect visible as a single video on all the centers lanes or their subsets.

The video mask projecting surface can be the entire wall surface above the pinspotter pits, the one usually covered by traditional static masking units. This space can be considered and designed to be a unique seamless projecting surface, allowing a displaying of images or effects covering the entire width of the lanes.

The content projected on this surface can be a global unique image/video/light special effect or more separate special effects, displayed individually in correspondence of single lanes or group of lanes.

Further, in operation, the video projection system 10 can be composed by a number of video projectors interspersed throughout the bowling center, e.g., over the Bowling Center Surfaces. These video projectors can use a camera device (or other detection device) to identify people and objects that cross onto the video projection surface area and enable the system to react and change the image being displayed by the projectors according to the motion of the person or object/objects in the video projection display area.

In embodiments, the video projectors are managed by the Centralized Management System 300.

Many kinds of lighting fixtures can also be controlled by the Centralized Management System 300 to create lighting effects and “mood” within the bowling center. These lighting fixtures can be multi-color lighting fixtures, e.g., LED lighting, above the bowling lanes in which the multi-color lighting fixtures, e.g., LED lighting, project lighting effects onto the lane surface, changing the color appearance of the lane surface and creating a nice visual effect on the bowling lanes, any of which are managed by the centralized management system 300.

These lighting fixtures are not limited to ones placed above the bowling lanes to project lighting effects on the lanes surfaces, but can also be placed on other locations to project directly or indirectly a lighting effect on other Bowling Center Surfaces such as on the static mask or video mask surfaces, on side walls, at the bowling consoles, under, around, above or inside (if some sort of transparency is possible) the bowling furniture.

Accordingly, in embodiments, the present invention provides interaction of the projection and lighting effect systems used in bowling centers with the bowling scoring and management system 100 to allow the video content, audio and lighting content delivered by these systems to respond to many different events, including scoring games and events occurring on the bowling lane (and that are known and managed usually by the scoring system). The result is that the bowling scoring and management system 100 can drive and also affect the video content delivered by the video projector system 10 (either with or without a camera/detection device for interactivity with the bowler and/or bowling ball) and/or effect lighting systems in the bowling center.

This integration and interaction can be achieved in many different ways because projection, audio and lighting systems can be provided with computerized control and standardized interfaces (i.e., the computerized system controlling the video projector is a computer and thus the computer software running on it can get input by the bowling scoring system through Ethernet). For example, the effects lighting control system may be a DMX controller that can be set up to interact with the bowling scoring and management system trough a DMX connection.

The audio, visual, lighting sequences can be triggered by “Bowling Modes”, that are predefined sets of parameters configured in the management system in order to automate management system controlled operations. Bowling modes can prescribe that a certain type of lighting is switched on at a predetermined hour of a predetermined day of the week. Additional parameters that can be used to set Bowling Modes are the type of customer, the type of bowling grid and animation theme chosen for the overhead monitors. The combination of two or more of these parameters can be used by the system to trigger one or more special effects to begin.

The integration of scoring and management system with the special effect devices allows automatically control of the special effects according to the Bowling Modes method, but also allows a direct manual control of each special effect device connected to the system, semi automated control as in when a set of special effect instructions are predefined to trigger a sequence or a combination of effects but they need an initial manual trigger. The manual or automatic control extends to each individual special effect and to each individual context of use, such as in the possibility to control special effects at each bowling center lane level, with a different effect or combination of effects for each lane, up to having the same special effect on a predefined set of lanes, up to having a single combination of all special effects working at the bowling center level, with center-wide effects.

In embodiments, the Video Mask system, e.g., graphic content processing system, can comprise at least one CPU capable of graphic content processing, preferably but not necessarily implemented by the management system 300 and one or more video projectors 10, with a unified surface extending on the whole width of the masking units. The one or more CPUs, e.g., a graphic content processing system, determine what to display on the masking units, treating the entire surface as a single unified element. In embodiments, the graphic content processing system can be represented by the computing system of FIG. 3 or the CPU of FIG. 2, which has a bidirectional communication with a management system 300 and scoring system 200. The system among its features allows the synchronization of the audio/video outputs among the video projectors. The content displayed can be dedicated to all the lanes or to a group of lanes, down to the single lane.

The Video Mask system, e.g., graphic content processing system, has a bi-directional communication with the scoring system 200, the management system 300 and the user I/O devices such as the scoring consoles, receiving inputs triggering the Video Mask system behaviors and sending inputs to the scoring system triggering scoring-related behaviors. For example,

The Video Mask system can include content activated by an event or a status relayed by the scoring system, although the projection or special effects will not be a scoring tabulation. By way of example, the lane whose total scoring enters in the top ten scores of the night gets a “high score” animation displayed on the video mask wall. The animation is managed by the Video Mask system, is displayed on the entire video mask wall and is dedicated to the specific lane (an arrow flying all over the video mask wall and stopping in correspondence of the lane). An event of the Video Mask system triggers the activation of a different status of the scoring system, if an event of the scoring system then happens in conjunction with the event of the Video Mask system, this triggers a specific behavior of the Video Mask system, and optionally of the management system. By way of example, the Video Mask system can manage a global game of chance, where a graphic sign or an animation projected on the video mask wall points to a different lane every 20 minutes, changing from lane to lane randomly. If any of the bowlers of the lane currently indicated by the sign scores a strike during this period of time, the bowler wins a prize. The management system 300 records the information of the prize won.

Mood generator system

A mood setting is a feature of the scoring system used to activate one or more of the special effects depending on a status of the bowling lane. The bowling lane status is defined as a set of predefined parameters (the graphic theme of the scoring grid and the scoring animations, name and gender of the bowlers, type of activity as in corporate party, birthday party, open bowling, special game active on the lane, highest score of the lane, average score of the lane, lane ranking in a tournament, etc . . . ) that according to their nature can be defined by the bowling center operators, by the bowlers directly using the bowling consoles, or automatically by the system (such as in a function capable of detecting the prevalent color displayed on a scoring monitor and providing the color instructions to be used for the RGB lane lights). For example,

(i) When at the last ball of a game a bowler could score a 300, all the lanes lights get dimmer than the lights of the lane, until the ball is thrown.

(ii) The lane in bowling center with the highest scoring of the last hour is lighted in a red light.

(iii) If the Oceanic environment (sea-themed scoring grid and animations) gets activated on a lane, the RGB lights on the lane automatically switch to blue.

The Mood Settings is a means of automatically managing scoring system-related actions triggering audio/video content display and special effects display. Thus, as Bowling Modes deal with management system automation, Mood Settings deal with scoring system and special effects automation. The two systems can work independently, or they can work together with Bowling Modes used to activate or deactivate a specific Mood Setting function.

In embodiments, the lighting special effects described above can be exploited to create a global or local mood setting effect center-wide, on all the center lanes, or on groups of lanes, up to single lanes, both alone or combined with video and or audio contents.

The mood generation is the combined effect of all the visual and auditory stimuli coming from the special effects generating devices. Video, lighting and audio can be used together or separately to induce an emotional response by the individuals or groups present in the bowling center, such as the ones actually bowling on the lanes or the ones attending a bowling sporting event played at the same center. The audio-visual means intended to generate said emotional response are controlled by the scoring system or the management system, which manage the effects to achieve the specific desired environmental setting or mood.

The mood generator system effects can comprise a number of predetermined set of instructions to be sent to the audio, video, lighting or other special effects devices in order to generate any of a predetermined set of “moods” or audio-visual environments. The effects can also be generated by combined any set of predetermined effects or can be custom—defined by the bowling center operators to achieve “moods” not initially predefined in the system, that can be then stored in the system memory and executed at need.

The effects instructions sets at one bowling center, both those predefined and those custom-defined by the center operators, can be shared with other bowling centers, being stored in a format (e.g.: a computer configuration file) allowing copying and transferring to a compatible system. This feature can be used by multi-center bowling chains to share common custom configurations among their centers without the need to reconfigure manually the audio, video, lighting system in each center. The same can happen among centers belonging to different owners, which can choose to define and share custom configuration not included in the predetermined set provided with the system.

The effects execution can be initiated manually by a bowling center operator or a bowler, automatically in response to a bowling game event recorded by the scoring system or to a scoring system set up, such as the scoring grid and animations theme active on a lane, and automatically in response to one or more predefined parameters not related to the scoring system activity such as the time of the day, the type of customer on the lanes, the number of lanes open. Additionally any combination of the above triggering events can be initiate an effects execution, such as the combination of a bowling game event happening when a specific type of customer plays in a determined moment of the days (the first strike shot by a group of young adults in a game taking place on a Saturday disco-themed night).

Examples of the interaction that are achieved by linking these devices to the bowling scoring and management systems include, amongst others and in no particular order of importance:

(i) Extend any graphic, environment, or scoring data available within the bowling and scoring management system 200 to the bowling lane, approach and masking unit or other surfaces.

(ii) Allow bowlers and bowling center staff to use the scoring consoles or a mobile device to choose content to be projected onto the bowling lane, approach, and masking unit or other surfaces. For example, there can be games within the scoring system that allow users to choose images or animations and project them on the lane surface (i.e. the bowling lane can look like grass, ice, a road, plasma, a night sky with stars, etc.).

Duplication of the scoring video content displayed on the scoring overhead monitors to other bowling center surfaces.

Complement the scoring video content displayed on the scoring monitors with additional and related content on the masking video unit wall. E.g. the scoring monitor could display the standard scoring grid for a game while a different graphic representation of the game standings can be projected on the video mask wall. E.g. the traditional bowling scoring grid could be displayed on the scoring overhead monitor while the video mask wall could display the outcome of a special non-bowling game based on the same bowling score of the game currently played on the lane. The special non-bowling game could also be a global game, based on the current bowling score of all the bowlers playing at the center, or on a center's lanes subset.

(iii) Allow bowlers and bowling center staff to create their own content through the scoring consoles or a mobile device and project it onto the bowling lane, approach, and masking unit or other surfaces (e.g., by using different patterns, brushes and stamps, etc. available kids can create their own picture on the lane, as if they were painting the lane). Graphic templates could be made available to users to help create audio, video, lighting effects, for example for embedding existing images or videos in predetermined graphic settings, such as uploading a picture of the winning bowler to the system, which then combines it with a predefined graphic such as a frame and then displays it on the video masking wall. Similar applications could be advertising product images or logos embedded in a blimp graphic that is then displayed as moving from one side of the video masking wall to the other side and back, as an advertising method. Other similar examples: scrolling or flashing messages displayed on any of the bowling center surfaces. Graphic banners displayed as moving on and around bowling center surfaces. Bowling center logo displayed and projected on said surfaces.

Display global exciters, such as a center-wide visual effect focusing on one lane in case a specific event happens, such as a strike, a spare or a special game win. An example of effect could be the image of an explosion beginning at the lane in case of a strike and expanding to the rest of the lanes or to the whole center, with coordinated lighting and audio effects.

Display on the entire width of the video mask wall, or on a video mask wall portion, the graphical representation of a global game based on bowling game events happening on the lanes. This game could be directly based on each bowler current score, on a random/chance-based game mechanism involving all or a subset of the bowlers currently playing in the center, or also including bowlers or individuals not currently bowling but physically present at the center (such as bowlers whose data are already stored in the management system database, already checked-in to play at a lane, but not playing yet). The same global game can be based on scoring, or under management system control, events happening in other centers at the same time, e.g. a global game whose participants are all the bowlers currently bowling in all the centers belonging to the same chain.

Center-wide interactive environments. E.g. a global audio, video, lighting effect featuring a ocean-themed representation across all lanes that is interactive based on lanes activity—such as with images of bubbles displayed on one lane surface when the system detects a ball has been thrown, or with animated themed characters reacting in real time to an event on the lane, such as a fish animated cartoon displayed down the lane moving away from an incoming ball.

Mixing sound background effects with center wide music.

Ambient lighting, e.g. a birthday party setup, where a group of children are playing on a more lanes, with the overhead monitors displaying a child-themed scoring grid graphic and video animation exciters, with simultaneous and coordinated display of a similarly-themed video content on the video masking section in front of the same lanes where the group is playing, with simultaneous lighting effects coordinated with the video content, such as to complement or reinforce the effect of what is displayed through the overhead monitors or the video projectors. Examples include:
diffused blue changing lighting in association with the ocean-themed scoring graphics and animations;
dramatic pulsing red lighting when one bowler is about to play a decisive ball; and
a custom background graphic is used by the system as background for the scoring grid on a pair of lanes; the system detects the prevalent color of the image and automatically generates a similarly colored ambient lighting for the lanes, the approach and the seating area to complement the image.

The system detects the prevalent color in a video content the customer or the center operators chose to display on a single lane overhead scoring monitor, or on the video mask wall, and it automatically and dynamically generates a matching colored ambient lighting for the same lane. The same effect can be extended to the entire center to match the color/feel of what's happening on one or more video screens, according the rules predefined at the scoring or management system level.

In embodiments, the scoring system status, starting from at least the status of single lane, up to the status of a group of lanes, can automatically control the behavior of or more special effects components according to a predefined set of instructions. As an example, if the scoring system has one lane currently set in a kids birthday party mode, then the special effects components of that lane will receive instructions to behave in a specific way associated with kids birthday parties, such as no fog/haze, a specific multicolored pattern, a laser effect drawing the names of the kids on the lane, etc. A different lane status could be of a lane where the last ball of a game is about to be thrown by a bowler, with that status associated to the RGB lights turning to the red color along the lane surface. A status could be detected by the scoring system 200 at the lane, such as the status of being currently open or closed, by a combination of such parameters as being open and with bowlers who choose our ocean-themed scoring animations on the overhead monitors. A status could also set on the scoring system by the management system, through the same automations we previously defined as bowling modes.

In embodiments, the scoring system, managing at least one bowling lane can be configured to process events related to the lane and manage special effect components. One or more special effects components are configured to provide special effects in response to the occurrence of status of the scoring system on the at least one bowling lane. A set of instructions links the status of the scoring system 200 at the least one lane with the special effect components. Upon the occurrence of a status, the scoring system: determines that the one or more lanes status is associated with one or more special effects, and provides the instructions to the one or more special effects associated to the status.

The status of the one or more lanes can be one of: being not available for playing, being available for playing but not currently used, being available for playing, and being currently used for a bowling game. The status of the one or more lane is defined by the theme characterizing the audio/video content displayed on the scoring overhead monitors. The status of the one or more lanes is defined by a characteristic of the audio/video content displayed on the scoring overhead monitors. The status of one of more lanes is defined by one or more characteristics of the setup at the one or more lanes, comprising at least one of: type of bowling game currently played, type of non-bowling game currently played, type of customers, status of the game (beginning, middle, last ball). The one or more special effects components provide special effects comprising at least one of video projection, multi-colored lighting, laser effects, audio effects, and fog/haze. A management system 300 can interact with the scoring system 200 and the status of the lane is determined by the management system through a bowling mode.

Mood Setting

Ability of the customer, the center's operators or the management system in an automated way to set the “mood” for one or more lanes, up to all the lanes and to the entire center, by having the system control the special effect devices in order to generate a specific combination of audio, video and lighting effects meant to elicit an emotional response by the individuals present in the bowling center. Mood setting can also be seen as an extension of the ambient lighting described above.

Further examples which can be implemented with the systems and control provided herein:

(i) An exciting mood with disco-styled music and lighting effects, with disco-dancing themed videos displayed across the center.

(ii) A relaxing mood for a lounge-style atmosphere, based on ambient music and a soft tranquil lighting setup.

(iii) Project a welcome screen onto the approach to welcome bowlers just arriving to the lane or other surfaces.

(iv) Video lighting exciters for individual lanes (in case of strikes, spares, killer shots); and special games exciters, e.g., the lane lights up if the current bowler wins a special game prize);

(v) Any graphic, environment, or scoring data available within the bowling and scoring management system can be sent to the bowling lane, approach area and masking unit or other surfaces.

(vi) Integrate with a redemption device 400 that delivers virtual tickets and tokens as images projected onto the lane surface.

(vii) Project any advertising messages and images originating from the scoring and management system onto the bowling lane, approach, and masking unit.

(viii) Project a topographic image representing the oil pattern onto the bowling lane.

(ix) Project a safety warning message or image onto the lane to warn bowlers not to cross the foul line and respect the bowling center rules.

(x) Project a foul video clip animation as soon as the scoring system detects that the foul detector unit has been tripped by someone crossing the foul line.

(xi) Extend any game managed by the scoring system to the Bowling Center Surfaces, e.g., lane surface, so the competition between lanes can be visualized on the lane surface, through a histogram starting from the end of the lane and growing towards the approach area. At every ball thrown the corresponding histogram bar grows. The first lane whose bar reaches the approach area wins.

(xii) Extend any game managed by the scoring system to the Bowling Center Surfaces, e.g., lane surface, displaying the scene on the lane surface, all across the bowling center. (i.e., a train image enters on lane 1 and moves across all adjacent lanes, going back and forth several times, getting closer to the approach with every time. When the train stops, all doors open and from one of the train cars a “You Won!” banner is displayed).

(xiii) Display scoring information directly on the lane or other bowling center surfaces, in addition to or instead of those shown on the monitors. For example:
Display nicknames, pictures and other data about the bowler on the lane and/or masking unit;
Display the score made with the latest ball thrown (i.e. “7” or “strike”) onto the lane and/or masking unit;
Celebrate remarkable scoring achievements with specific animations on the lane and/or masking unit (i.e. “three strikes in a row”);
Show bowler standings and recap data on the lanes and/or masking unit; and/or
Display an histogram on the lane, one bar per bowler with name and current score, to show intuitively how the match is proceeding and who's leading and following.

(xiv) Allow bowlers to use the scoring consoles to create content images (avatar) that will follow the ball path down the lane.

(xv) Integrate with a sound system to create specific sounds that react to the ball motion and/or graphical images. For example, a gutter ball is accompanied by a sound effect.

(xvi) Integrate a spare finder projected onto the bowling lane to show bowlers where to throw the ball using arrows on the lane (extension of the spare finder in the scoring system).

(xvii) Project the ball path onto the lane to help bowlers learn and improve their performance (e.g., use a different color for first and second ball, colored stripes displayed at specific positions on the lane, with the ball that has to pass in between).

(xviii) Keep the history of the ball paths and project them onto the lane to show how consistent the bowler is in their bowling patterns.

(xix) Improve safety in the bowling center by using the system to identify everything that does not look like a bowling ball that crosses the foul line onto the lane and warn bowlers by projecting visual and sonic alerts and stopping the pinspotting machine is the shape gets too close.

Project a static image on the masking units to mimic a static printed masking unit, allowing centers that need to have non-distracting animated graphing on the masking units in some contexts (league playing) to replicate the look and feel of a standard static printed masking unit. Alternatively the image projected can be non-static, but designed in a way as not to distract the bowlers, such as a slow moving image, that can be different for each lane or for groups of lanes or a global image for the entire masking unit wall, or an image, static or moving, displayed on all the bowling center surfaces not limited to the lanes, including side walls and other walls of the bowling center and of the ancillary and connected rooms and environments, such as the bowling center restaurant.

Bowling center operators could feed one or more video sources, as TV, DVD, streaming video or audio signals, to the integrated audio, video, lighting system for redistribution inside the center. One or more signals could be fed to the “mood generator” sub-system to be processed and displayed or projected on selected bowling center surfaces together with the matching lighting conditions. One of more signals could be alternatively or simultaneously fed to the integrated audio, video, lighting system for display or projection on bowling centers surfaces at the same time of the “mood” content is displayed. This could allow as an example to have some lanes with a corporate party where an audio video content is displayed on the video maskings using the “mood generator” while on other lanes a plain video, different from the first one, such as a football match, is displayed to other bowlers.

### FURTHER EXAMPLES

The following are further examples using a Landscape Video Mask system which can be implemented with the systems and controls provided herein and as shown in the figures.

More specifically, the effects and/or special functions described herein can be implemented with the video projection system 10 and lighting fixtures 30 using the bowling scoring and management system 100, e.g., Lane-Score-Computer 200 and centralized management system 300, as examples.

Level 1—Center Mood Generator

In embodiments, synchronized graphical landscape uses global animations, where the animation uses all lanes. This includes, e.g., LED lighting for curtain and side walls to match the colors/feel of what is happening on the video screen. The system includes a library of predefined video and lighting sequences (including themed sound output to the center sound system), with sequences triggered by Bowling Modes. The system provides flexibility to create moods selectable by blocks of lanes (discrete control of which programs go to which lanes, pairs or larger groups) and the flexibility and discrete control over individual LED lighting effects and selections for advanced users who want to build their own sequences, e.g., have a way to share libraries and custom themes to help provide more options for all centers who have the product. The synchronized graphical landscape is connected to input from the center sound system to respond to music/beats.

For traditional bowling (daytime, white building lighting), the system can provide static graphics, e.g., digital masking panels, and can show “traditional” masking unit patterns for uniformity across the center for certain segments. A slow screen saver-like effects, to avoid distractions, can also be provided.

The multimedia content includes, e.g., TV, DVD, MMS, etc. Two options include: one input into the “mood generator” to take a source and include it into “framed” portions of the landscape and one input at each pair to let centers send whatever they want to a pair (we control mood generator display vs. this input by pair via Conqueror). In embodiments, HD video can be required. The system will also manage common/standard input types.

The systems also include emergency mode for when the controller/server is not available, e.g., basic display using the LED lighting for a single, non-changing color so the space is filled while the system is restored (alternate consideration: a basic manual controller for the LED lights that can be used if the system would be down for an extended period). The systems can be customized (advertising, branding, etc.). This can include templates to allow display of images or video in creative ways (plane flies across with banner, train drives across with boxcars, etc.). The centers are also provided with an easy way to get imagery in without any graphics knowledge. The systems can combine image(s) with available animation/style options (like customized scoring grids on the mask). The systems further include scrolling messages to cross the entire centers. This can be scrolling or flashing, etc. For example, the center logo can be moving around, with transparent things going around, or banner-like messages.

The systems also include ambient/light/color effects, e.g., integration with other LED color light sources as created and added into the mood programs described herein. Thus can include, e.g., LED lane lights (separate document); Pit lights; Capping lights; and/or bumper lights. The systems further include integrated remote screen and projector control.

The Landscape Video Mask will support energy management, e.g., the centers have the ability to disable/dim/reduce sections or components of the system when they would not be in use.

Level 2—Lane-Based Scoring Integrated

In this embodiment, video/LED lighting scoring exciters are provided for individual lanes (strikes, spares, killer shots, etc.). The systems can include special games exciters (e.g. light up when selected for specific games); giant scoring grids, e.g., which could be themed to match specific scoring masks/environments;, or which could be complimentary content as opposed to replicating what is on the overhead monitors.

Level 3—All Lanes Scoring Integrated

In embodiments, systems include global games, including existing ones converted for specific use with a Landscape Video Mask system; and new games for specific themes and targets. Also, the systems can provide random/chance/competition and fun games.

In embodiments, global exciters/events can include global animations focusing on one lane e.g., for strike, spare (like an explosion that expands out). Center-wide interactive environments can include, e.g. the Landscape Video Mask system featuring an Oceanic-themed aquarium across all lanes that is interactive based on lane activity- such as bubbles that come up on a lane when a ball is thrown, with characters reacting to various things. Also contemplated are mix sound background/effects with the center-wide music output to the center's sound system. The global selections can be available by session like other scoring products today (e.g., set/group of lanes).

Physical requirements/characteristics:

The physical requirements and characteristics can include: (i) single giant virtual screen; (ii) White screen used by light and sound/special effect equipment; (iii) Bright in all conditions, not only in the dark; and (iv) Requires scoring for lane interaction; and (v) option to fit low ceilings (single mask height) and/or high ceilings (double mask height and more). This does not require video to double height, but does require that the physical mask structure fits different scenarios and that the entire area is used through combination of video and LED lighting.

LED Lane Lighting system Level 1—Center Mood generator/Center Lighting

In embodiments, the systems include complete coverage from the foul line to the masking units, optional module for approaches, bowler's area or concourses. The systems include LED Lane Lighting system and Landscape Video Mask combined which will have a different configuration then when LED Lane Lighting system is standalone. The systems can be standalone product or fully integrated and synchronized with the Landscape Video Mask. “Traditional” white lighting when special effects are not needed or appropriate can be used. Color temperature, brightness and general look and feel should be the same as traditional center lighting (fluorescent or others). In embodiments, color wash effects can be provided including for single lane, group of lanes and the entire center. The systems are connected to input from the center sound system to respond to music/beats. Also, the systems can provide ambient/light/color effects, integrated with other LED color light sources as created which are added into the mood programs mentioned above. Again, the systems include, e.g., a Landscape Video Mask system; pit lights; capping lights; and bumper lights. The systems further include emergency mode for when the controller/server is not available, e.g., default display of “traditional” white lighting or quick way for the center to manually achieve this (a center cannot be without any lighting). The systems support energy management, where centers have the ability to disable/dim/reduce sections or components of the system when they would not be in use.

Level 2—Lane-Based Scoring Integrated

Systems include LED lighting scoring exciters for individual lanes (strikes, spares, killer shots, etc.) -lane blinks, flashes, color change, etc. Systems further include special games exciters (e.g. light up when selected for specific games). Systems further include colors/theme to complement scoring mask/environment extended to lane (e.g., blues for Oceanic, match color of signature grid, etc.), both static, mix of colors and dynamic changes. Systems include safety systems, e.g., Warning/blinking when the foul line is crossed or the automated trouble control system indicates to stop bowling. Systems include “Welcome” mode to get bowlers to their lane and “Standby” mode for power savings, e.g., during “traditional” white lighting mode, have all lanes not in use at a reduced intensity and only “light up” lanes once turned on (not completely dark and appearing that the center is closed, but not bright lights on all the time).

The above options are not all necessary with the idea of a global mood, specifically when combined with the lane video mask system . There can be provided a balance when offering controls and settings to allow centers to find the right mix. (e.g., safety mode might be preferred on nearly all the time except for leagues while “environment” type things might not be wanted during moods etc.)

Level 3—All Lanes Scoring Integrated

Systems include effects for global games (e.g., lanes light up and follow a specific animation etc. Systems further include Global exciters/events, with global effects focusing on one lane e.g. for strike, spare, and effects moving/chasing on all the lanes for extreme bowling center.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed:

1. A special effects system comprising:
one or more special effects components which display images or effects on a projecting surface in a bowling center to provide a global effect within the bowling center; and
a graphic content processing system which has a bidirectional communication with a management system and a scoring system, the graphic content processing system directing the special effects components to display special effects on the projecting surface over the entire width of the bowling lanes or portions thereof.

2. The special effects system of claim 1, wherein the projecting surface comprises masking units for at least each bowling lane and the masking units are a unified surface extending over the entire width of the bowling lanes or portions thereof, and the special effects system treats as a single element all of the masking units or a portions thereof.

3. The special effects system of claim 2, wherein the one or more special effects components includes one or more video projectors, with the special effects system manages the synchronization of the audio/video outputs among the one or more video projectors to provide a unified video content.

4. The special effects system of claim 1, wherein the graphic content processing system and user I/O devices including scoring consoles are in communication with one another, and the graphic content processing system receives inputs which trigger the special effects from the I/O devices, and the graphic content processing system sends inputs to the scoring system to trigger scoring-related behaviors on one or more masking units associated with a respective bowling lane.

5. The special effects system of claim 1, wherein content to be displayed by the graphic content processing system is activated by an event or a status relayed by the scoring system.

6. The special effects system of claim 5, wherein the content is related to a scoring event at a single bowling lane and the content is displayed on a masking unit of the single bowling lane in which the scoring event took place.

7. The special effects system of claim 6, wherein the content is displayed on the entire projecting surface and is dedicated to a specific bowling lane related to the scoring event at the specific bowling lane.

8. The special effects system of claim 7, wherein the content includes a sequence of projections displayed on the entire projecting surface and stopping at the specific bowling lane.

9. The special effects system of claim 1, wherein one of:
a detected event by the graphic content processing system triggers activation of a different status of the scoring system;
when an event of the scoring system happens in conjunction with an event of the graphic content processing system, the event of the scoring system will trigger a specific behavior of the graphic content processing system; and
the event of the scoring system will trigger a specific behavior of the management system.

10. The special effects system of claim 2, wherein the graphic content processing system will direct the special effects components to display the special effects on the projecting surface over the entire width of bowling lanes or portions thereof, independently from the scoring system.

11. The special effects system of claim 2, wherein the management system records an event of a bowler in order to award a prize.

12. A video mask projection system, comprising:
a unified projecting surface; and
at least one special effect device which displays images or effects covering an entire width of the bowling lanes or portions thereof, wherein the displayed images projected on the unified projecting surface comprise at least one of a global image, video and light displayed individually in correspondence of single lanes or group of lanes, which is controlled independently of a scoring system and which can be integrated with a scoring system.

13. The video mask projection system of claim 12, wherein the content is a global video game based on scoring events generated on the bowling lanes, which comprises a global video effect visible as a single video on all masking units or subsets thereof, independent of a score recorded by the scoring system.

14. The video mask projection system of claim 13, wherein the scoring system and a management system are integrated with the special effect devices and which are configured to automatically control special effects according to bowling modes, including a direct manual control, an automatic control or a semiautomatic control of each special effect device connected to the scoring system and the management system.

15. The video mask system of claim 14, wherein the semi automated control comprises a set of special effect instructions predefined to trigger a sequence or a combination of effects but with an initial manual trigger, on a predefined set of bowling lanes.

16. The video mask system of claim 14, wherein the special effect devices are triggered by predefined parameters not related to the scoring system.

17. A system, comprising:
a scoring system configured to manage at least one bowling lane including processing events related to the at least one bowling lane; and
one or more special effects components managed by the scoring system and configured to provide special effects in response to an occurrence of a status of the scoring system on the at least one bowling lane, wherein, upon the occurrence of the status, the scoring system:
determines that the one or more bowling lanes status is associated with one or more special effect components; and
provides instructions to the one or more special effect components associated to the status to provide the special effects.

18. The system of claim 17, wherein the status of at least one bowling lane is one of: being not available for playing, being available for playing but not currently used, being available for playing, and being currently used for a bowling game.

19. The system of claim 17, wherein the status of the at least one bowling lane is defined by one of:
a theme characterizing audio/video content displayed on scoring overhead monitors;
a characteristic of the audio/video content displayed on the scoring overhead monitors; and
one or more characteristics of a setup at the at least one bowling lane, comprising at least one of: type of bowling game currently played, type of non-bowling game currently played, type of customers, and status of game.

20. The system of claim 19, wherein the status of the at least one bowling lane is determined by a management system through a bowling mode.

21. The system of claim 17, wherein a bowling lane status is defined as a set of predefined parameters that according to their nature can be defined by bowling center operators, by bowlers directly using bowling consoles, or automatically.

22. The system of claim 21, wherein the predefined parameters include at least one of graphic theme of a scoring grid, scoring animations, name and gender of bowlers, type of activity, highest score of the lane, average score of the lane, and lane ranking in a tournament.
